(19) United States
(12) Patent Application Publication
(10) Pub. No.: US 2003/0217369 A1
(43) Pub. Date: Nov. 20, 2003

(54) Flexible application information formulation

(76) Inventor: Edwin Arturo Heredia, San Jose, CA (US)

Correspondence Address: LEE & HAYES PLLC, 421 W RIVERSIDE AVENUE SUITE 500, SPOKANE, WA, 99201

(21) Appl. No.: 10/150,616

(22) Filed: May 17, 2002

(51) Int. Cl. H04N 7/16; H04N 7/20; H04N 7/173

(52) U.S. Cl. 725/152; 725/63; 725/68; 725/131; 725/132; 725/151; 725/109

(57) ABSTRACT

A protocol enables flexible formulation of application information data structures for television-based entertainment systems. The protocol may be a textual-based language such as markup language, including an extensible markup language. The application information data structure includes information that enables a client device to access and/or to activate one or more applications. The one or more applications may be software modules, files, images, text, executable programs, and so forth, including both bound and unbound applications. An application information data structure, or table, may be created at a headend of a television system and stored there in memory. The application information table may also be transmitted from the headend to a client device and stored in a memory of the client device. The client device is able to determine the existence of, and relevant parameters for utilizing, applications at the client device using the application information table.

### TECHNICAL FIELD

This disclosure relates in general to entertainment application information and in particular, by way of example but not limitation, to creating, communicating, and using flexible application information formulations.

### BACKGROUND

Television-based entertainment systems are expanding the programming and services that they offer. In addition to television programs such as those found on broadcast and traditional cable networks, television service providers are adding interactive services and features. These television service providers, such as cable and satellite television providers, are utilizing the increased functionality that results from switching to digital formats for transmitting, displaying, and/or otherwise utilizing audio, video, and data information. Digital formats, while not necessarily required, facilitate the implementation of interactive services and features such as electronic program guides (EPGs), digital program recording using an EPG, e-mail capability, information that overlays regular programming, web-surfing, real-time chats, image displaying, game playing, and so forth.

The software and other data information that powers the above enumerated and other services and features are typically referred to collectively as applications. For example, a particular application provider may provide a shopping application that enables a television user to purchase via the television an item being sold on a home shopping channel. Alternatively, the particular application provider may provide a shopping application that enables a television user to continue shopping on a traditional shopping network or a web-based store while channel surfing over many different channels. The former is an example of a bound application, and the latter is an example of an unbound application. Bound applications are applications that pertain and/or relate to a particular television program and/or channel. Unbound applications are applications that do not necessarily pertain or relate to a particular program and/or channel; hence, unbound applications may be interacted with continuously as a television user changes channels or as programs change on a single channel.

Application providers may offer a multitude of such bound and unbound applications to a television provider. After accepting many of them, the television provider has available dozens, or maybe even hundreds, of applications that need to be subsequently provided to television subscribers using cable equipment, satellite equipment, and the like. Additionally, each application may have information associated therewith that is necessary or useful for activating or otherwise interacting with the application.

Accordingly, for television-based entertainment systems, there is a need for schemes and techniques to enable a television provider to provide information about applications to a television user, as well as a need for means to display and/or otherwise utilize and interact with the applications at the television user's television.

### SUMMARY

A protocol enables flexible formulation of application information data structures for television-based entertainment systems. The protocol may be a textual-based language such as markup language, including an extensible markup language. The application information data structure includes information that enables a client device to access and/or to activate one or more applications. The one or more applications may be software modules, files, images, text, executable programs, and so forth, including both bound and unbound applications. An application information data structure, or table, may be created at a headend of a television system and stored in a memory of the headend. The application information table may also be transmitted from the headend to a client device and stored in a memory of the client device. The client device is able to determine the existence of, and relevant parameters for utilizing, applications at the client device using the application information table.

### BRIEF DESCRIPTION OF THE DRAWINGS

The same numbers are used throughout the drawings to reference like and/or corresponding aspects, features, and components.

FIG. 1 illustrates an exemplary television system architecture in which the systems and methods for flexible application information formulations can be implemented.

FIG. 2 illustrates an exemplary client device, a television, and various input devices that interact with the client device.

FIG. 3 is a block diagram that illustrates components of the exemplary client devices shown in FIGS. 1 and 2.

FIG. 4 is a block diagram that illustrates components of an exemplary application information formulation system as may be implemented with the architecture of FIG. 1.

FIG. 5 illustrates exemplary language elements for creating an application information table as an extensible markup language (XML) file.

FIG. 6 illustrates exemplary transmission modes for applications described in an XML-based file.

FIG. 7 illustrates an exemplary communication from a headend to a client and an exemplary utilization at the client of an application information table.

FIG. 8 is a flow diagram that illustrates a method for creating an application information table at a headend of a television-based entertainment system.

FIG. 9 is a flow diagram that illustrates a method for communicating an application information table from a headend to a client device in a television-based entertainment system.

FIG. 10 is a flow diagram that illustrates a method for utilizing an application information table at a client device of a television-based entertainment system.

### DETAILED DESCRIPTION

The following discussion is directed to television-based entertainment systems, such as interactive TV networks, cable/satellite networks that utilize electronic program guides and other applications, and Web-enabled TV networks. Client devices in such systems range from full-resource clients with substantial memory and processing resources, such as TV-enabled personal computers and TV recorders equipped with hard-disks, to low-resource clients with limited memory and/or processing resources, such as traditional set-top boxes. While aspects of the described systems and methods can be used in any of these systems and for any types of client devices, they are described primarily in the context of the following exemplary environment.

Exemplary System Architecture

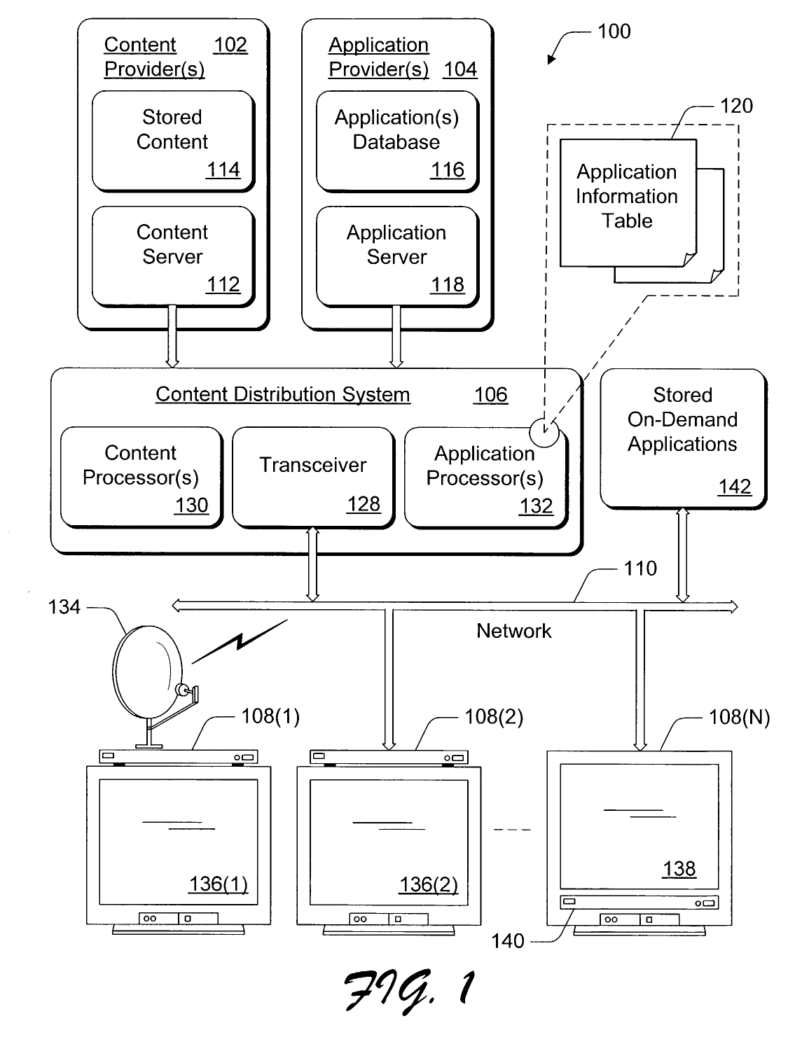

FIG. 1 illustrates an exemplary television entertainment system 100 that is an architecture in which flexible application information formulations may be implemented. System 100 facilitates distribution of content, applications, and application information to multiple viewers. System 100 includes one or more content providers 102, one or more application providers 104, a content distribution system 106, and multiple client devices 108(1), 108(2), . . . , 108(N) coupled to content distribution system 106 via a network 110.

Content provider 102 includes a content server 112 and stored content 114, such as movies, television programs, commercials, music, and similar audio and/or video content. Content server 112 controls distribution of stored content 114 from content provider 102 to content distribution system 106. Additionally, content server 112 may control distribution of live content (e.g., content that was not previously stored, such as live feeds) and/or content stored at other locations to content distribution system 106.

Application provider 104 includes an applications database 116 and an application server 118. Applications database 116 stores applications and optionally information associated with the applications. Applications include software modules, files, images, text, executable programs, and so forth. Information associated with the applications includes instructions for running/using an application, initialization data for an application, location/accessing information for an application, requirements for an application, security aspects for an application, and so forth. Application server 118 processes the applications and the information associated therewith from applications database 116 prior to distribution to generate one or more files that are optimized for, or at least capable of, transmission to content distribution system 106.

The pre-distribution processing may involve any number of techniques to reduce, modify, or organize the applications and the information associated therewith to produce a distribution version. Such techniques might include selection of applications, application(s) compression, format modification, and the like. Application server 118 controls distribution of the applications and the information associated therewith from application provider 104 to content distribution system 106 using, for example, a file transfer protocol (FTP) over a TCP/IP network (e.g., Internet, UNIX, etc.). Further, the distribution version of the applications and the information associated therewith can be transmitted from application provider 104 via a satellite directly to a client device 108.

Content distribution system 106 includes a transceiver 128, one or more content processors 130, and one or more application processors 132. Transceiver 128 can alternatively be a broadcast transmitter if bidirectional communication is not required. Transceiver 128 transmits (e.g., broadcasts) signals, such as cable/satellite television signals, across network 110. Network 110 can include a cable television network, RF, microwave, satellite, and/or data network, such as the Internet, and may also include wired or wireless media using any transmission format or protocol. Additionally, network 110 can be any type of network (including a broadcast network), using any type of network topology and any network communication protocol, and can be represented or otherwise implemented as a combination of two or more networks.

Content processor 130 processes the content received from content provider 102 prior to transmitting the content across network 110. Similarly, application processor 132 processes the applications (and the information associated therewith) that is received from application provider 104 prior to transmission of the applications across network 110. A particular content processor 130 may encode, or otherwise process, the received content into a format that is understood by the multiple client devices 108(1), 108 (2), . . . , 108(N) that are coupled to network 110. Although FIG. 1 shows a single content provider 102, a single application provider 104, and a single content distribution system 106, the exemplary system 100 can include any number of content providers and/or application providers coupled to any number of content distribution systems.

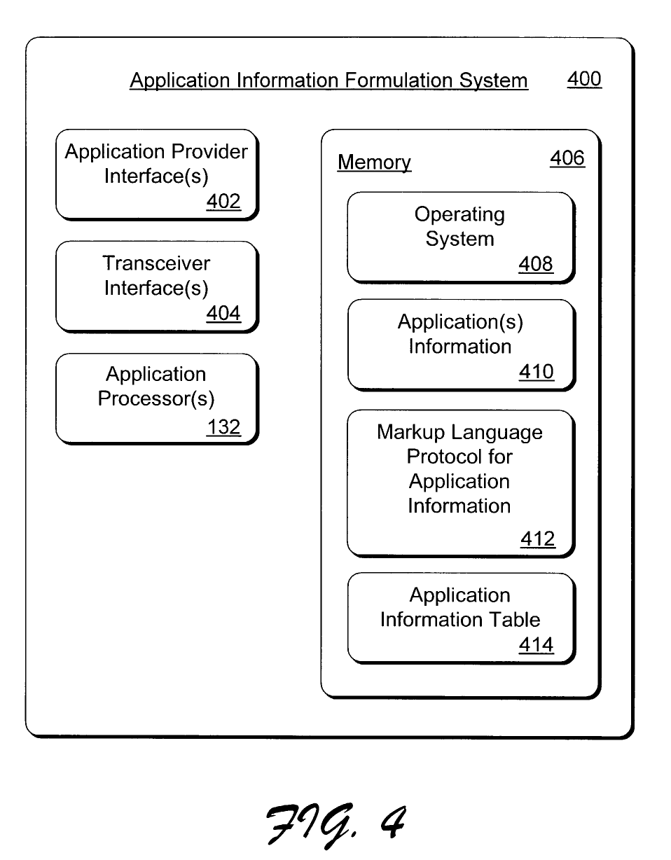

Additionally, application processor(s) 132 create one or more application information tables 120. To create an application information table 120, application processor 132 works as part of an application information formulation system 400, as is described further below with reference to FIG. 4. Application information table 120 is created based on applications and information associated with the applications that are received at content distribution system 106 from application provider 104. Application information table 120 is also created based on selections and/or decisions that are made by an operator of content distribution system 106. Application information table 120 is also provided from content distribution system 106 over network 110 to client devices 108. Client devices 108 are capable of accessing application information table 120 and of extracting the information therefrom. Such information enables client devices 108 to be aware of and to utilize the various applications received from application provider 104 via content distribution system 106.

Thus, content distribution system 106 is representative of a headend service that provides applications and an application information table 120 (as well as content) to multiple subscribers. In one implementation, content distribution system 106 utilizes a carousel file system to repeatedly broadcast applications and/or an application information table 120 over an out-of-band (OOB) channel of network 110 to client devices 108. In this example, client devices 108 can therefore gradually accumulate an entire set of files that includes the applications and an application information table 120 from content distribution system 106 without specifically requesting any of the files.

Client devices 108 can be implemented in a number of ways. For example, a client device 108(1) receives content and applications from a satellite-based transmitter via a satellite dish 134. Client device 108(1) is also referred to as a set-top box or a satellite receiving device. Client device 108(1) is coupled to a television 136(1) for presenting the content and applications (e.g., audio information, video information, and/or data information) that are received by the client device 108(1), as well as for presenting a graphical user interface. A particular client device 108 can be coupled to any number of televisions 136 and/or similar devices that can be implemented to display or otherwise render content. Similarly, any number of client devices 108 can be coupled to a single television 136.

Client device 108(2) is also coupled to receive content and applications from network 110 and to provide the received content and applications to associated television 136(2). Client device 108(N) is an example of a combination television 138 and integrated set-top box 140. In this example, the various components and functionality of the set-top box are incorporated into the television, rather than using two separate devices. Set-top box 140 that is integrated into television 138 can receive signals (e.g., broadcast signals) via a satellite dish (similar to satellite dish 134) and/or via network 110. In alternate implementations, client devices 108 may receive signals via the Internet or any other network, especially those network mediums that are broadcast-capable.

The exemplary system 100 also includes stored on-demand applications 142, such as those applications only available directly from an application provider. These applications can also be run or otherwise utilized by users of client devices 108 in conjunction with televisions 136 and 138. The stored on-demand applications 142 may be accessible over network 110 (i.e., a network that also provides content from content distribution system 106). Alternatively, stored on-demand applications 142 may be accessible over a different network, including a wide area network (WAN), the Internet, and so forth.

Exemplary Client Device

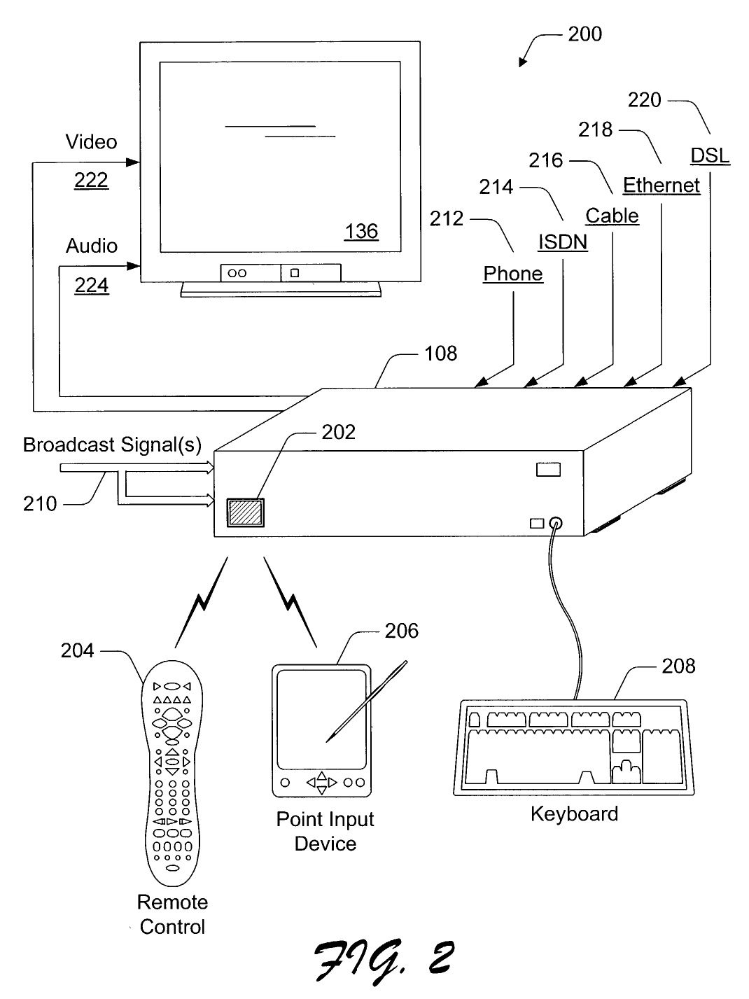

FIG. 2 illustrates an exemplary implementation 200 of a client device 108 shown as a standalone unit that connects to a television 136 and communicates with various input devices 204, 206, and 208. Client device 108 can be implemented in any number of embodiments, including as a set-top box, a satellite receiver, a TV recorder with a hard disk, a digital video record (DVR) and playback system, a game console, an information appliance, and so forth.

Client device 108 includes a wireless port 202, such as an infrared (IR) or Bluetooth wireless port, for receiving wireless communications from a remote control device 204, a handheld input device 206, or any other wireless device, such as a wireless keyboard. Handheld input device 206 can be a personal digital assistant (PDA), handheld computer, wireless phone, or the like. Additionally, a wired keyboard 208 can be coupled to communicate with client device 108. In alternate embodiments, remote control device 204, handheld device 206, and/or keyboard 208 may use an RF communication link or other mode of transmission to communicate with client device 108.

Client device 108 receives one or more (e.g., broadcast) signals 210 from one or more broadcast sources, such as from a satellite or a cable or a broadcast network, including a broadcast implementation of network 110 (of FIG. 1). Client device 108 includes hardware and/or software for receiving and decoding a broadcast signal 210, such as an NTSC, PAL, SECAM or other TV system video signal. Client device 108 also includes hardware and/or software for providing the user with a graphical user interface by which the user can, for example, access various network services, configure client device 108, and perform other functions, including utilizing applications.

Client device 108 can communicate with other devices via one or more connections including a conventional telephone line 212, an ISDN link 214, a cable link 216, an Ethernet link 218, a DSL link 220, and the like. Client device 108 may use any one or more of the various communication links 212-220 at a particular instant to communicate with any number of other devices.

Client device 108 generates video signal(s) 222 and audio signal(s) 224, both of which are communicated to television 136. Video signals 222 and audio signals 224 can be communicated from client device 108 to television 136 via an RF (radio frequency) link, S-video link, composite video link, component video link, co-axial cable link, or other communication link. Although not shown in FIG. 2, client device 108 may include one or more lights or other indicators identifying the current status of the device. Additionally, the client device may include one or more control buttons, switches, or other selectable controls for controlling operation of the device.

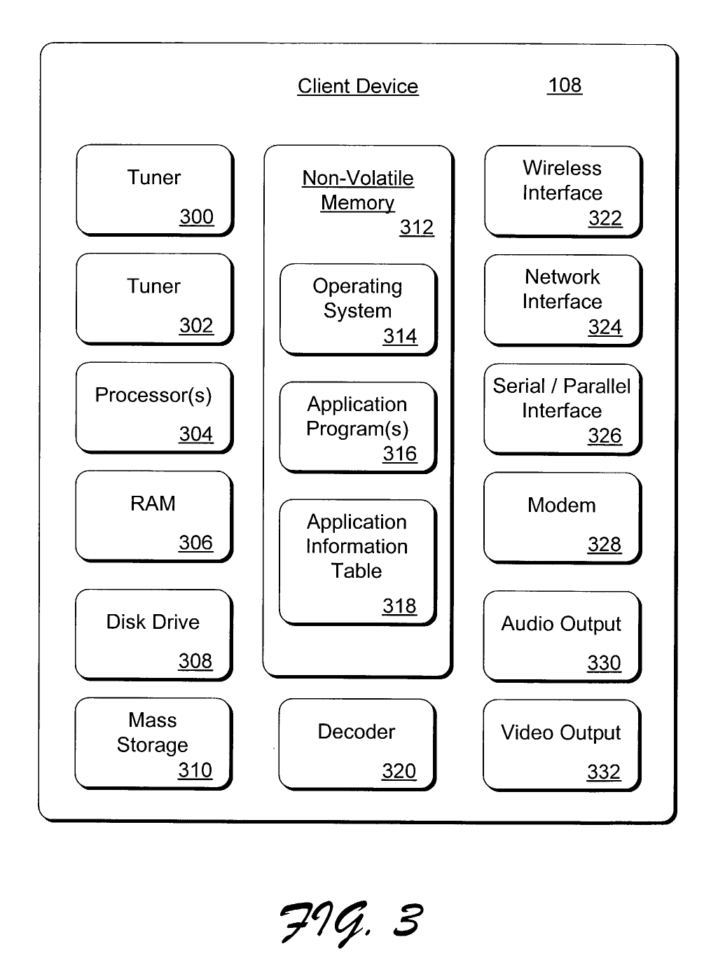

FIG. 3 illustrates selected components of exemplary client device 108 shown in FIGS. 1 and 2. Client device 108 includes a first tuner 300 and an optional second tuner 302. The tuners 300 and 302 are representative of one or more in-band tuners that tune to various frequencies or channels to receive television signals, as well as at least one OOB tuner that tunes to the broadcast channel(s) over which data information is broadcast (e.g., carouseled or otherwise transmitted) to client device 108.

Client device 108 also includes one or more processors 304 which process various instructions to control the operation of client device 108 and to communicate with other electronic and computing devices. Client device 108 can be implemented with one or more memory components, examples of which include a random access memory (RAM) 306, a disk drive 308, a mass storage component 310, and a non-volatile memory 312 (e.g., ROM, Flash, EPROM, EEPROM, etc.). The memory components (e.g., RAM 306, disk drive 308, mass storage 310, and non-volatile memory 312) store various instructions and/or information such as received content, applications, configuration information for client device 108, and/or graphical user interface information.

Alternative implementations of client device 108 can include a range of processing and memory capabilities, and may include more or fewer types of memory components than those illustrated in FIG. 3. For example, full-resource clients can be implemented with substantial memory and processing resources, including the disk drive 308 to store content for replay by the viewer. Low-resource clients, however, may have limited processing and memory capabilities, such as a limited amount of RAM 306, no disk drive 308, and limited processing capabilities of a processor 304.

An operating system 314 and one or more programs may be stored in non-volatile memory 312 (and/or another memory component) and executed on processor 304 to provide a runtime environment. A runtime environment facilitates extensibility of client device 108 by allowing various interfaces to be defined that, in turn, allow the programs to interact with client device 108. Although these programs may be installed when client device 108 is manufactured, they may also be application programs 316 that are received from a content distribution system 106 (of FIG. 1) and/or are utilized with reference to application information table 318. Application information table 318 may correspond to application information table 120 (also of FIG. 1) that is received from content distribution system 106 and may convey information on one or more applications.

Application programs 316, which is also referred to herein as applications 316, includes software modules, files, images, text, executable programs, and so forth. Applications 316 may be received at client device 108 from applications database 116, stored on-demand applications 142, and so forth, in manners described above with reference to FIG. 1. Application information table 318 includes information on utilizing applications 316. For example, application information table 318 may inform client device 108 (i) of the existence of particular applications, (ii) of the location of particular applications, (iii) of how to execute or otherwise access and present to a user particular applications, (iv) of needed or helpful initialization parameters, and so forth. Hence, client device 108 interprets application information table 318 so as to be able to activate/provide applications 316 for/to a user of the device.

Applications 316 include at least two different types of applications: bound applications and unbound applications. Bound applications are tied to (i.e., bound to) a particular television program and/or television channel. An example of a bound application is a stock ticker application that presents stock price quotes along the bottom edge of a television screen on a finance channel. Such a bound stock ticker application may be interactive so that a user may select to see the price of certain stocks. Such a bound stock ticker application may continue to run during commercials on the finance channel, but it ceases to display or otherwise function if the channel is changed. Another example of a bound application is a stats application that displays current stats for a football game (either interactively or not), but ceases to update or otherwise function correctly if the channel is changed or when the football game broadcast ends.

Examples of unbound applications include a web browsing application, an e-mail correspondence application, a game, a (e.g., web-based) shopping application, political election result reporting, and so forth. Each of these examples of unbound applications are categorized as being unbound because each application may continue running correctly as programs and/or channels are changed. Consequently, a user of a client device 108 may continue playing a chess game against an opponent while channel surfing between (or during) chess moves.

As an example clarifying the distinction between bound and unbound applications, a football game stats application is categorized as unbound if a user may continue to view, organize, request that different stats be displayed, etc. after the football game is over and a new program such as a matinee movie has commenced. In short, client device 108 may utilize/activate bound or unbound applications of application programs 316 by relying on the information of application information table 318. Such utilization and/or activation may include displaying or otherwise presenting audio-visual information, running an executable program, enabling an interactive TV service, and so forth.

Client device 108 also includes a decoder 320 to decode a broadcast video signal, such as an NTSC, PAL, SECAM or other TV system video signal. Processor 304, along with tuner(s) 300 and 302 and/or decoder 320, also enables client device 108 to reconstruct audio and video from an MPEG-2 stream or other digital packet signal. Client device 108 can also include other components pertaining to a television entertainment system which are not illustrated in this example. For instance, client device 108 can include a user interface application and user interface lights, buttons, controls, and the like to facilitate viewer interaction with the device.

Client device 108 further includes a wireless interface 322, a network interface 324, a serial and/or parallel interface 326, and a modem 328. Wireless interface 322 allows client device 108 to receive input commands and other information from a user-operated input device, such as from a remote control device or from another IR, Bluetooth, or similar RF input device. Network interface 324 and serial and/or parallel interface 326 allows client device 108 to interact and communicate with other electronic and computing devices via various communication links. Although not shown, client device 108 may also include other types of data communication interfaces to communicate with other devices. Modem 328 facilitates communication by client device 108 with other electronic and computing devices via a conventional telephone line.

Client device 108 also includes an audio output 330 and a video output 332 that provide signals to a television or other device that processes and/or presents or otherwise renders the audio and video data. Although shown separately, some of the components of client device 108 may be implemented together in an application specific integrated circuit (ASIC). Additionally, a system bus (not shown) typically connects the various components within client device 108. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Exemplary Application Information Formulation System

FIG. 4 illustrates selected components of an exemplary application information formulation system 400 as may be implemented with the architecture shown in FIG. 1. The exemplary application information formulation system 400 creates an application information table, such as the application information table 120 (of FIG. 1). The application information formulation system 400 may be implemented as part of content distribution system 106. This implementation is represented by application processor 132 (of FIG. 1) being used in application information formulation system 400.

Alternatively, application information formulation system 400 may be implemented as a separate unit, as part of application provider 104, and so forth. In either of these two implementations, a created application information table may be provided to content distribution system 106 for subsequent distribution to client devices 108. However, in the description of FIG. 4, application information formulation system 400 is considered to be part of content distribution system 106.

Application information formulation system 400 includes one or more application provider interfaces 402 that facilitate communication between application information formulation system 400 and one or more application providers 104 (of FIG. 1). Application information formulation system 400 also includes one or more transceiver interfaces 404 that facilitate the passing of a created application information table from application information formulation system 400 to the transceiver 128 for distribution to client devices 108.

Application information formulation system 400 includes one or more application processors 132 (as also shown in FIG. 1) and one or more memory components 406. Examples of possible memory components include a random access memory (RAM), a disk drive, a mass storage component, a non-volatile memory (e.g., ROM, Flash, EPROM, EEPROM, etc.), and so forth. Alternative implementations of application information formulation systems can include a range of processing and memory capabilities, and may include more or fewer types of memory components than those described. Application processor(s) 132 process various instructions to control the operation of application information formulation system 400 and to communicate with other electronic and computing devices (including other parts of content distribution system 106 and/or other aspects of exemplary television entertainment system 100).

An operating system 408 may be stored in memory 406 and executed on application processor 132. Also stored in memory 406 are application information 410, markup language protocol for application information 412, and application information table 414. Application information 410 is received from application provider 104 and optionally from other sources that supply and/or aid in the activation of applications. Application information 410 includes information that is associated with the applications provided by application provider 104. As described above, such information entails instructions for running/using an application, initialization data for an application, location/accessing information for an application, requirements for an application, security aspects for an application, and so forth. Markup language protocol for application information 412 provides a framework for creating application information table 414 based on application information 410 and selections and preferences of an operator of content distribution system 106 (of FIG. 1). Application information table 414 corresponds to application information table 120 as stored in memory 406.

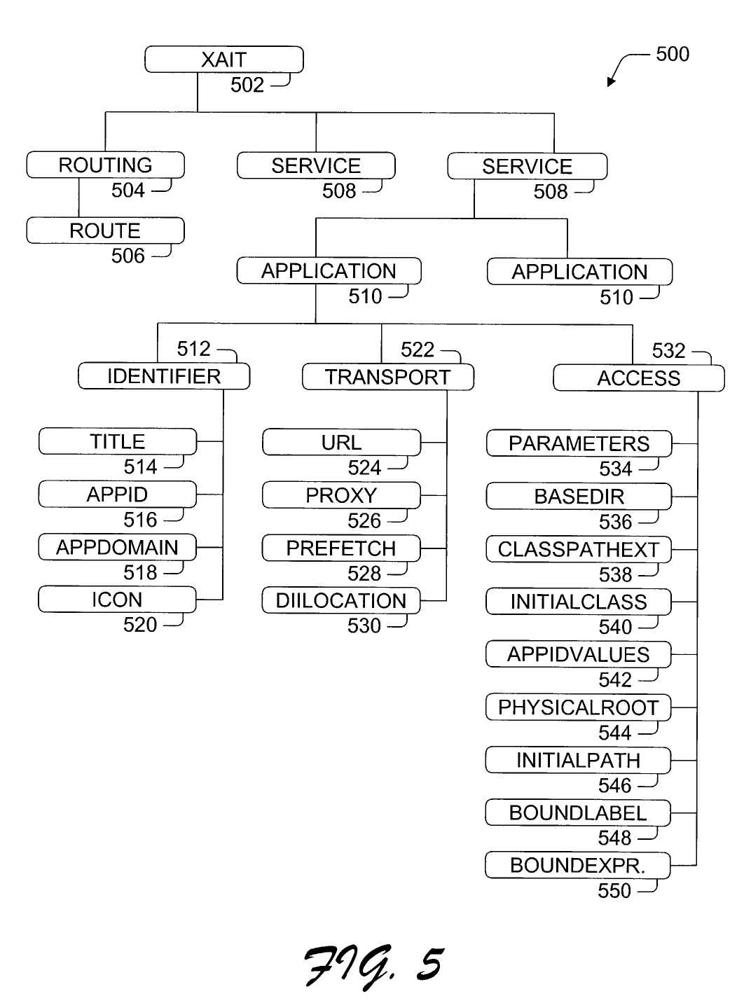

An exemplary markup language protocol, or more generally a schema, for application information 412 is described below in general terms with reference to FIG. 5 and in conjunction with Table 1. More specifically, (i) an exemplary document type definition (DTD) for markup language protocol for application information 412 and (ii) an exemplary instantiation thereof for application information table 414 are presented below in text form. The elements of markup language protocol for application information 412 are used to define and identify fields of application information table 414. For example, fields of application information table 414 may be created that define and identify an application with attributes such as version, lorder, type, etc. and which beget children fields such as those corresponding to TRANSPORT and IDENTIFIER elements. These and other possible fields are described below in terms of elements and attributes in the Table 1 and with reference to FIG. 5.

FIG. 5 illustrates exemplary language elements in tree 500 for creating an application information table as an extensible markup language (XML) file. The language elements may be used to create an XML file for declaring application signaling. Thus, application information table 414 (of FIG. 4) may be created as an XML file using the language elements of tree 500; however, other approaches such as using a different markup or other textual language may alternatively be employed. Tree 500 diagrammatically indicates which elements may admit children elements in markup language protocol for application information 412 (of FIG. 4). For example, the TRANSPORT 522 element may admit as children the following elements: URL 524, PROXY 526, PREFETCH 528, and DIILOCATION 530. Each element may have one or more attributes to describe various application properties, such as transport, functionality, initialization, and SO forth.

Table 1 and tree 500 therefore serve as a general exemplary document type definition (DTD) for an XML-based application information table (XAIT). The resulting XML-based signaling protocol may be used in a television entertainment environment for interactive TV and the like. Specifically, a created XAIT may be used to signal the existence of applications (including monitor applications) in, for example, an OpenCable Applications Platform (OCAP) environment. An XAIT may signal for both bound and unbound applications. Each element entry in Table 1 includes a number that corresponds to the reference number of the element in tree 500 of FIG. 5. For example, the XAIT element is identified by the reference number “502” in both Table 1 and tree 500.

TABLE 1
Elements and attributes for an exemplary extensible markup
language (XML) protocol for application information tables.

| ELEMENT | ATTRIBUTES | DESCRIPTION |
|---|---|---|
| XAIT | version | Identifies the XAIT content. |
| 502 | | An XAIT element admits |
| | | ROUTING and SERVICE elements |
| | | as children elements. |
| ROUTING | sourceID | Defines the portion of the |
| 504 | tsid | document that lists the IP routing |
| | ipver | relations between IP addresses and |
| | | MPEG-2 elementary streams. |
| | | Attribute sourceID indicates the |
| | | multiplex where the mapping |
| | | actually occurs and may be omitted |
| | | if it corresponds to the same |
| | | multiplex that carries the XAIT file. |
| | | Attribute tsid indicates the |
| | | Transport Stream ID which may be |
| | | used in some systems instead of a |
| | | sourceID. Attribute ipver gives the |
| | | version of IP addressing (that is, |
| | | either 4 or 6). |
| | | A ROUTING element admits |
| | | ROUTE elements as children |
| | | elements. |
| ROUTE | componentTag | Defines a particular link |
| 506 | address | between an IP address and certain |
| | port | MPEG-2 elementary stream. |
| | mask | The attributes defined for this |
| | | element correspond to similar fields |
| | | in the IP routing descriptors defined |
| | | in the signaling portion. |
| SERVICE | version | Defines an abstract service and |
| 508 | serviceID | provides the current version and its |
| | | identifier (serviceID). |
| | | A SERVICE element admits |
| | | one or more APPLICATION |
| | | elements as children elements. |
| APPLICATION | version | Defines an unbound application. |
| 510 | lorder | It includes a version attribute to |
| | type | indicate possible updates. The |
| | monitor | lorder attribute defines a launch |
| | control | order for applications within an |
| | visibility | abstract service. The application |
| | priority | type is either “ocap-html” or “ocap- |
| | | j”. The monitor Boolean flag |
| | | indicates whether this application is |
| | | a monitor application. The |
| | | attributes for visibility and priority |
| | | are similar to comparable |
| | | definitions in the application |
| | | descriptor defined for the AIT, |
| | | except that instead of binary values, |
| | | visibility admits equivalent text |
| | | values of “none”, “onlyapps”, and |
| | | “all”. |
| | | An APPLICATION element |
| | | admits IDENTIFIER, ACCESS, |
| | | and TRANSPORT elements as |
| | | children elements. |
| IDENTIFIER | | Defines the portion of the |
| 512 | | document that provides |
| | | identification parameters for |
| | | applications. |
| | | An IDENTIFIER element |
| | | admits TITLE, APPID, |
| | | APPDOMAIN, or ICON elements |
| | | as children elements. |
| TITLE | xml:lang | This element encloses text that |
| 514 | | defines the title of an application in |
| | | a certain language defined using the |
| | | xml:lang attribute. Language |
| | | encoding shall follow the rules |
| | | defined in RFC 1766. |
| APPID | organizationID | This element provides the same |
| 516 | applicationID | functionality as the |
| | | application_identifier() descriptor in |
| | | the AIT. |
| | | It defines two basic |
| | | identification attributes: |
| | | organizationID and applicationID. |
| APPDOMAIN | domain | This element defines a domain |
| 518 | | name that may be used instead of |
| | | (or jointly with) applicationID and |
| | | organizationID. The use of domain |
| | | names may be more appropriate for |
| | | applications that rely mostly on |
| | | documents distributed throughout |
| | | the Internet. |
| ICON | locator | This element provides the same |
| 520 | flags | functionality as the application |
| | | icons descriptor of the AIT. |
| | | The attributes locator and flags |
| | | are defined as part of the same |
| | | descriptor. |
| TRANSPORT | protocol | This element defines the |
| 522 | sourceID | different transport protocols that |
| | tsid | may be used to carry unbound |
| | componentTag | applications. This element includes |
| | alignment | some functionality that is similar to |
| | uhttp | the transport protocol descriptor in |
| | IPMaddress | the AIT. |
| | | The protocol attribute admits |
| | | values “oc” for object carousel, “ip- |
| | | bcast” for multiprotocol |
| | | encapsulation over MPEG-2, and |
| | | “ip-ret” for TCP/IP over the return |
| | | channel. Attributes sourceID and |
| | | tsid were explained before (see |
| | | description of ROUTING element |
| | | above) and when included, they |
| | | indicate that the actual data objects |
| | | come in a different multiplex. The |
| | | attribute componentTag is used by |
| | | object carousels to point to a |
| | | specific program element. The |
| | | attribute alignment is used by |
| | | multiprotocol encapsulation to |
| | | define if datagrams and sections are |
| | | aligned. The Boolean flag uhttp |
| | | indicates if the UHTTP protocol is |
| | | used on top of multiprotocol |
| | | encapsulation, and if it is, attribute |
| | | IPMaddress may be used to define |
| | | a particular multicast address used |
| | | for delivering the actual data |
| | | objects. |
| | | A TRANSPORT element admits |
| | | URL, PROXY, PREFETCH, and |
| | | DIILOCATION elements as |
| | | children elements. The first one |
| | | (URL) is used one or more times by |
| | | multiprotocol encapsulation as |
| | | defined in the transport protocol |
| | | descriptor of the AIT. The second |
| | | one (PROXY) is used one or more |
| | | times to define a proxy server for |
| | | an application located in an outside |
| | | network, and the third |
| | | (PREFETCH) and fourth |
| | | (DIILOCATION) ones are used by |
| | | object carousels. |
| URL | | This element encapsulates text |
| 524 | | that defines a Uniform Resource |
| | | Locator (URL). The text format |
| | | must comply with RFC 2396. |
| PROXY | | This element encapsulates text |
| 526 | | that defines the address of a proxy |
| | | server. The format for the text is |
| | | the standard dot-separated notation |
| | | of Internet addresses. |
| PREFETCH | module | This element provides similar |
| 528 | priority | functionality to the prefetch |
| | | descriptor defined in the AIT. |
| | | The attributes module and |
| | | priority are used to indicate a |
| | | preferred prefetching sequence. |
| DIILOCATION | diiID | This element provides similar |
| 530 | associationTag | functionality to the DII location |
| | | descriptor defined in the AIT. |
| | | Attributes diiID and |
| | | associationTag are used to list and |
| | | to define the identifier and the tag |
| | | of those carousels that belong to the |
| | | selected object carousel of an |
| | | application. |
| ACCESS | | This element identifies the |
| 532 | | portion of the document that |
| | | defines access parameters necessary |
| | | to run an application. It does not |
| | | have any attributes. |
| | | An ACCESS element |
| | | incorporates as children elements |
| | | the nine (9) elements 534-550 listed |
| | | below starting with |
| | | PARAMETERS 534 and ending |
| | | with BOUNDEXPRESSION 550. |
| PARAMETERS | | This element encapsulates text |
| 534 | | that defines the start parameters |
| | | passed to an application for |
| | | running. The dvb-j and dvb-html |
| | | application descriptors in the AIT |
| | | define the meaning of this element. |
| BASEDIR | | This element encapsulates text |
| 536 | | that defines the base directory for |
| | | ocap-j applications. More details |
| | | are provided in the AIT. |
| CLASS- | | This element encapsulates text |
| PATHEXT 538 | | that defines the classpath extension |
| | | for ocap-j applications. More |
| | | details are provided in the AIT. |
| INITIALCLASS | | This element encapsulates text |
| 540 | | that defines the initial class for |
| | | ocap-j applications. More details |
| | | are provided in the AIT. |
| APPIDVALUES | | This element encapsulates text |
| 542 | | that describes an array of |
| | | applicationID values that are |
| | | applicable to ocap-html |
| | | applications. More details are |
| | | provided in the AIT. |
| PHYSICAL- | | This element encapsulates text |
| ROOT 544 | | that defines the physical root for |
| | | ocap-html applications. More |
| | | details are provided in the AIT. |
| INITIALPATH | | This element encapsulates text |
| 546 | | that defines the initial path of ocap- |
| | | html applications. More details are |
| | | provided in the AIT. |
| BOUNDLABEL | | This element encapsulates text |
| 548 | | that defines a label for the |
| | | boundaries of ocap-html |
| | | applications. This element mirrors |
| | | functionality that exists in the |
| | | application boundary descriptor in |
| | | the AIT. |
| BOUND- | | This element encapsulates text |
| EXPRESSION | | that defines an expression for the |
| 550 | | boundaries of ocap-html |
| | | applications. This element mirrors |
| | | similar functionality that exists in |
| | | the application boundary descriptor |
| | | in the AIT. |

Table 1 above presents a general description of elements and attributes for an XML-based application information table. A more specific exemplary DTD for an XML-based application information table is presented textually below. The elements and attributes of Table 1 are an example of a markup language protocol for application information 412 (of FIG. 4). They may be used, together with application information 410, by an operator of a content distribution system 106 to create a specific application information table 414 that is appropriate for the applications to be offered by the operator. A specific exemplary application information table is also presented textually below as an exemplary instantiation of an XML-based application information table. The exemplary instantiation shows how various elements and attributes are collected or grouped together into sets or entries that relate or otherwise correspond to a higher level element or elements (or attribute(s) thereof).

Specific implementations of application information table 414 include multiple tags and arguments thereof. The multiple tags may correspond to elements or attributes as presented in Table 1 above, and the arguments thereof correspond to values that are appropriate to the given tag. An example of a possible passage for an application information table 414 is: <APPLICATION version=“2” lorder=“2” type=“ocap-j” monitor=“false” control=“autostart” visibility=“all” priority=“2”>. In this passage, the argument of the tag “version” is “2”, and the argument of the tag “type” is “ocap-j”. The operator selects which tags are relevant given the available applications, the network configuration, and SO forth. For some elements as dictated by the applicable DTD, if a particular element is not relevant, then the operator may omit it from the application information table 414 that is being created.

When a specific application information table 414 is being created, all unbound services may be clearly demarcated by using SERVICE 508 element and therefore identified by proper selection of a service identifier. Applications that belong to that service may be grouped together therewith. The relevant tags and arguments thereof that are associated with a given application are grouped under the corresponding APPLICATION 510 element. The markup language protocol for application information 412 is flexible and not based on fixed tables or mandatory binary lengths and organization. An application information table 414 need not be divided by section tags that indicate section breaks. Furthermore, because related information may be grouped or collected together using this flexible approach, application information that is associated with other application information need not be separated in an application information table. For example, there is no need to include an internal pointer from one piece of application information to another related piece of application information that is located elsewhere in the application information table because related information can be grouped together.

Many of the elements and attributes of Table 1 and FIG. 5 facilitate the utilization of applications by a client device. For example, the SERVICE 508 element includes a serviceID attribute that provides a service identification that may correspond to, for example, the application service provider that provides the applications of children elements. Also, the lorder attribute of the APPLICATION 510 element defines a launch order for applications within an abstract service. An operator can therefore ensure that one application starts before another application. The ROUTING 504 element includes a sourceID attribute that indicates the multiplex where the address mapping occurs. An identification source is used by cable operators predominantly in the United States.

Additionally, the APPDOMAIN 518 element provides a pointer to web applications (e.g., using a URL). It therefore enables direct invocations of web applications from the URL or similar. The TRANSPORT 522 element includes an additional approach for distributing files and streams in a broadcast manner using the uhttp and IPMaddress attributes. The uhttp attribute indicates if the UHTTP protocol is used on top of multiprotocol encapsulation, and if so, the IPMaddress attribute defines the multicast address used for delivering the data objects.

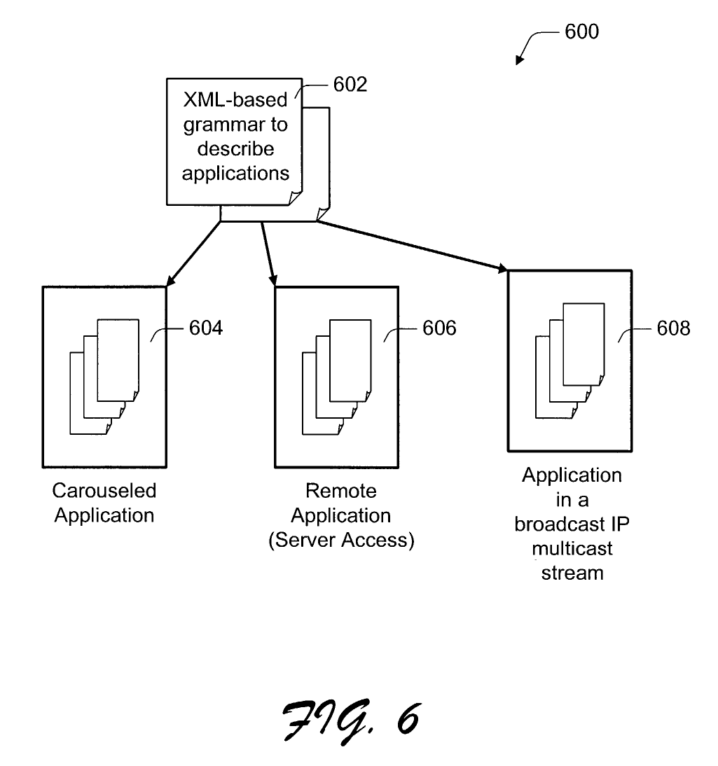

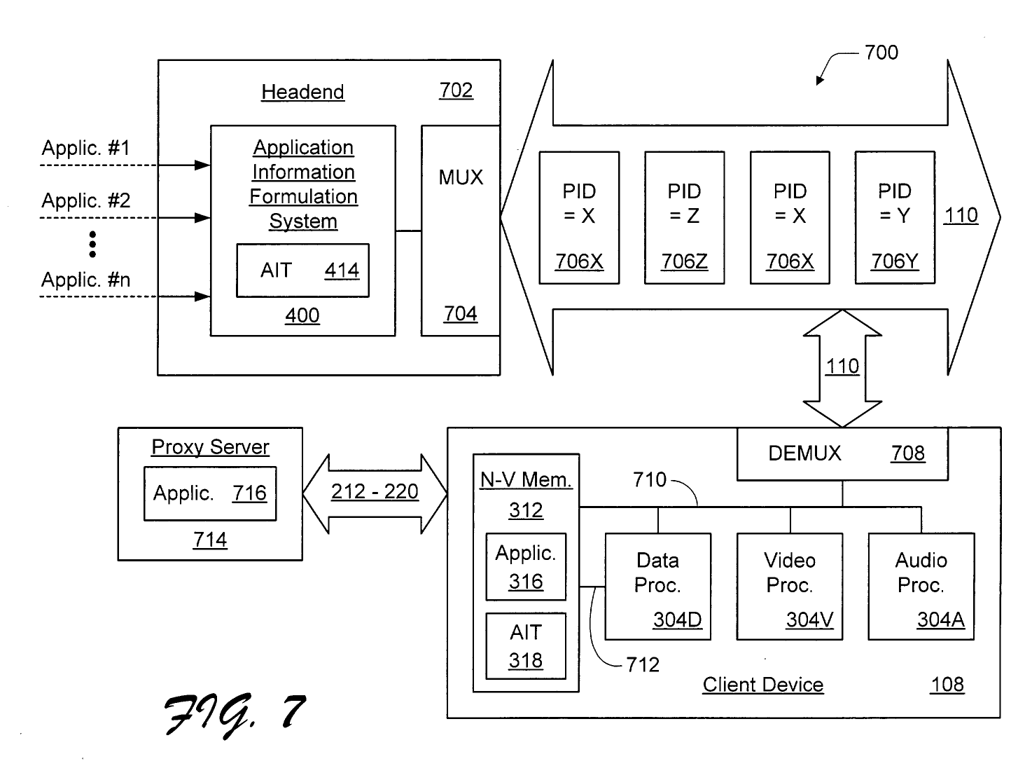

As another example, the TRANSPORT 522 element has several optional attributes and children elements. One of these optional children elements is the PROXY 526 element. The PROXY 526 element pertains to a proxy server, which is an example of a location corresponding to stored on-demand applications 142. If a particular application must or may be procured from a proxy server according to the provider of the particular application, or if an operator otherwise elects to use a proxy server, then the PROXY 526 element is included in the portion of application information table 414 that corresponds to that particular application. An example of the use of a proxy server is provided below with reference to FIG. 7. Other application delivery options among which an operator may choose in addition to server access are presented below with reference to FIG. 6.

Distribution Examples for Applications and AITs

FIG. 6 illustrates exemplary transmission modes for applications described in an XML-based file. XML-based grammar such as that presented in Table 1 above is used to describe applications in an XML-based application information table 602. The XML-based AIT 602 is created at a headend of a cable/satellite provider and provided to multiple client devices 108, where it is used to access and activate applications. The applications may be distributed to client devices 108 in a myriad of manners. These distribution manners include distributing the applications as a carouseled application 604, as a remote application (e.g., via server access) 606, as an application in a broadcast IP multicast stream 608, and so forth. The protocol attribute of the TRANSPORT 522 element (of FIG. 5) is used to indicate which delivery option or options are used to distribute any particular application. A given client device 108 may therefore access the XML-based AIT 602 in order to determine how to acquire a desired application.

FIG. 7 illustrates an exemplary communication from a headend to a client and an exemplary utilization at the client of an application information table. Television entertainment environment 700 includes a headend 702 that is in communication with a client device 108 over network 110. Headend 702 includes application information formulation system 400 (of FIG. 4). As such, headend 702 may comprise content distribution system 106 (of FIG. 1). In this case, applications #1, #2, . . . #n arrive at application information formulation system 400 from an “external” source (as indicated from the dashed line portion of the arrows) such as application provider 104. Alternatively, headend 702 may comprise content distribution system 106 and all or part of application provider 104. In this case, applications #1, #2, . . . #n arrive at application information formulation system 400 from an “internal” source (as indicated from the solid line portion of the arrows) such as application database 116 via application server 118.

In either case, applications #1, #2, . . . #n arrive at application information formulation system 400 for processing. The applications #1, #2, . . . #n, along with received information associated with the applications (e.g., application information 410 of FIG. 4), are processed to create application information table (AIT) 414. This application information table 414 creation process is explained herein with reference especially to FIGS. 4, 5, and 8 and Table 1. A file of application information table 414 is divided into packets by multiplexer 704 for transmission onto network 110.

Each packet placed on network 110 includes a packet identification (PID) for subsequent identification and re-combination at destinations such as client device 108. Exemplary packets 706X, 706Y, and 706Z are shown being transmitted on network 110. The packets 706 may be transmitted over network 110 in accordance with, for example, an MPEG-2 type data stream. Three different PIDs are attached to the four packets 706. These three PIDs are X, Y, and Z. Multiplexed packets 706 are demultiplexed at demultiplexer 708 at client device 108. Packets with a PID of X, for example, are amalgamated with other packets with a PID of X. Similarly, packets with a PID of Y are amalgamated with other packets with a PID of Y, and so forth.

Client device 108 is informed by headend 702 of which packets are to be utilized in a given situation based on the PID of the packets. Headend 702 sends a program map table (PMT) to client device 108. The PMT indicates which PIDs map to which programs. For example, the PMT may indicate that all packets with a PID of A correspond to audio information for channel 10, that all packets with a PID of V correspond to video information for channel 10, and that all packets with a PID of D correspond to data information for channel 10. Hence, if a user instructs client device 108 to tune to channel 10, then client device 108, by consulting the PMT, knows to recombine all packets with PIDs of A, V, and D for processing by audio processor 304A, video processor 304V, and data processor 304D, respectively. The processed results are then forwarded to a television 136/138 (of FIGS. 1 and 2) to be presented to the user as channel 10. Other channels also have entries in the PMT for determining which packets correspond thereto.

Different applications that are broadcast over network 110 may also have entries in the PMT. For example, application #1 may correspond to packets with PIDs of A1, V1, and D1, and application #2 may correspond to packets with PIDs of A2, V2, and D2. In this implementation, application information table 414 also has an entry in the PMT. For example, all packets with a PID of X may correspond to a file of application information table 414. Consequently, after client device 108 consults the PMT, client device 108 knows to amalgamate all packets 706 from network 110 that have a PID=X (i.e., all packets 706X). Hence, demultiplexer 708, optionally in conjunction with data processor 304D over bus 710, recombines packets 706X until the application information table is re-created. The application information table 318 of client device 108 is stored in non-volatile memory 312.

Non-volatile memory 312 stores application(s) 316 in addition to application information table 318. Data processor 304D may access application information table 318 over bus 710 or dedicated bus 712 to determine what applications 316 are available and how to activate them, as well as how to provide interactions with them. The applications 316 may be distributed to client device 108 in a multitude of manners as described above with reference to FIGS. 1 and 6. For instance, applications may be carouseled 604 or broadcast in an IP multicast stream 608 over network 110. In these cases, network 110 may be a cable network, a satellite network, a telecommunications network, the Internet, and so forth. Applications may also be distributed via remote server access 606. In this case, the application may be remotely accessed from a proxy server 714, which may correspond to stored on-demand applications unit 142 (of FIG. 1).

When client device 108 determines to run a particular application (e.g., because it is a monitor application, because a user has selected it, etc.), data processor 304D accesses application information table 318 and checks to determine whether the particular application is already stored as part of applications 316. If the application information table 318 indicates that the particular application is located at application(s) 716 of proxy server 714 (e.g., via the protocol attribute of the TRANSPORT 522 element for the APPLICATION 510 element of that particular application) and if the particular application is not already stored as part of applications 316, then client device 108 retrieves the particular application from proxy server 714. Client device 108 uses one of the communications lines/links 212-220 (of FIG. 2) to access proxy server 714 and to retrieve the particular application from applications 716. The retrieved particular application is stored as part of applications 316 at client device 108. Client device 108 can then activate the particular application. Proxy server 714 may alternatively be accessed over network 110 using the same or a different network interface as the one that receives applications that are carouseled or broadcast in an IP multicast stream from headend 702.

Methods for Creating, Communicating, and Utilizing AITs

Creating, communicating, and utilizing application information tables may be described in the general context of computer-executable instructions. Generally, computer-executable instructions include routines, programs, objects, components, data structures, and the like that perform particular functions or implement particular abstract data types. Creating, communicating, and utilizing application information tables may also be practiced in distributed computing environments where functions are performed by remote processing devices that are linked through a communications network. In a distributed computing environment, computer-executable instructions may be located in both local and remote computer storage media, including memory storage devices.

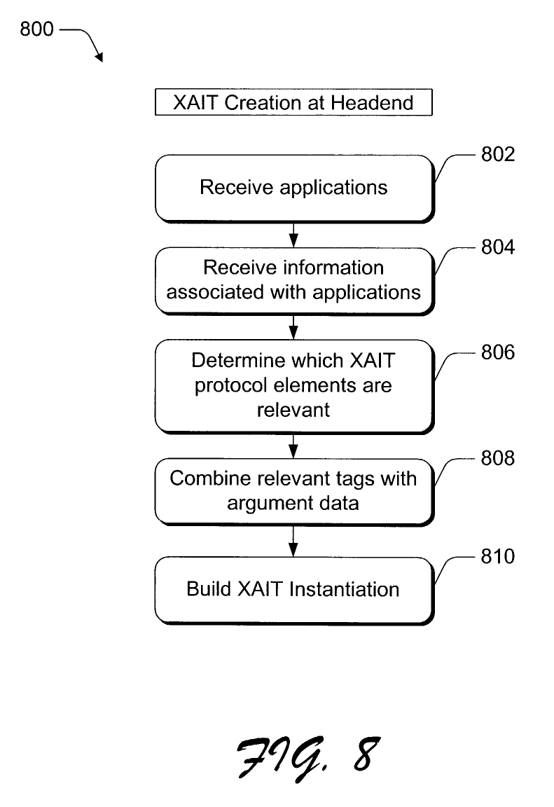

The methods of FIGS. 8-10 are illustrated in flow diagrams divided into multiple method blocks. However, the order in which the methods are described is not intended to be construed as a limitation, and any number of the described method blocks can be combined in any order to implement one or more methods for creating, communicating, and/or utilizing application information tables. Furthermore, although the methods are described below with reference to television entertainment environments 100 and 700 where applicable, the methods can be implemented in any suitable hardware, software, firmware, or combination thereof.

FIG. 8 is a flow diagram 800 that illustrates a method for creating an application information table at a headend of a television entertainment system. At block 802, a headend receives applications. The applications #1, #2, . . . #n may be received at headend 702 from an “external” source such as application provider 104 that constitutes a separate entity or from an “internal” source such as when application provider 104 is part of headend 702. Additionally, applications may be received specifically from applications database 116 via application server 118. At block 804, a headend receives information that is associated with the applications. The application information 410 may be received from the same source from which the associated applications were received or a different source. Additionally, information associated with applications 410 may be selected or otherwise determined by an operator of a content distribution system 106. For example, the operator may determine how particular bound and unbound applications are to be distributed. Part of the application information 410 that is associated with such particular bound and unbound applications is determined accordingly.

From the information associated with applications and the applications themselves, an operator at a headend determines which application information table elements are relevant at block 806. For example, an operator inspects pre-set and determinable attributes for applications that are to be available to users of client devices 108 and selects which markup language-based elements 412 are applicable and which ones may or should be included in an application information table 414 to be transmitted to client device 108. These markup language-based elements 412 may correspond to the elements of FIG. 5 and Table 1. Thus, the operator determines which XAIT protocol elements are relevant for the application information table being created.

At block 808, an operator combines relevant tags and argument data from the selected attributes and elements of the markup language-based protocol. These tags and argument data are combined with appropriate headings and formatting to build an application information table 414 at block 810. In other words, an operator builds a specific XAIT instantiation at block 810. The XAIT instantiation is created from the XAIT DTD, from the relevant applications, and from the parameters thereof for the specific implementation targeted by the operator.

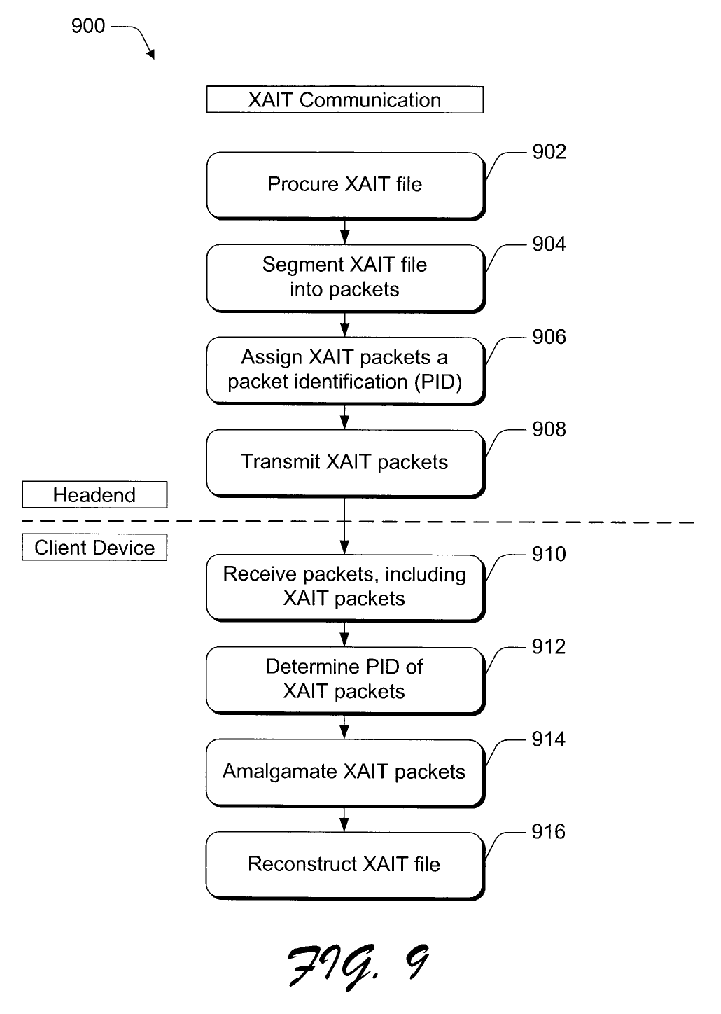

FIG. 9 is a flow diagram 900 that illustrates a method for communicating an application information table from a headend to a client device in a television entertainment system. Blocks 902-908 are performed at least primarily by a headend 702, and blocks 910-916 are performed at least primarily by a client device 108. At block 902, an XAIT file that has been created is procured. This XAIT file 414 may be procured from a local memory 406 at the site of content distribution system 106 or a remote memory source. At block 904, the XAIT file is segmented into packets. At block 906, the XAIT packets are assigned packet identifications (PIDs). The packet segmentation and PID assignment may be effectuated by multiplexer 704 and/or application processor 132. At block 908, the XAIT packets are transmitted. The transmission of the XAIT packets may be effectuated by multiplexer 704, transceiver interface 404, and/or transceiver 128, depending on how the underlying transport mechanisms are implemented for network 110.

At block 910, a client device receives packets, including packets carrying a portion of an application information table. For example, client device 108 receives packets 706 from network 110, including packets carrying part of an XAIT. At block 912, the client device determines the PID of packets carrying portions of the XAIT. For example, client device 108 may consult a PMT to determine which PID corresponds to the XAIT packets. At block 914, the XAIT packets are amalgamated by the client device. Client device 108 collects packets that correspond to the XAIT for recombination into a file. At block 916, the client device reconstructs the XAIT file. Thus, client device 108 may store the reconstructed XAIT file as an XML-based AIT 318.

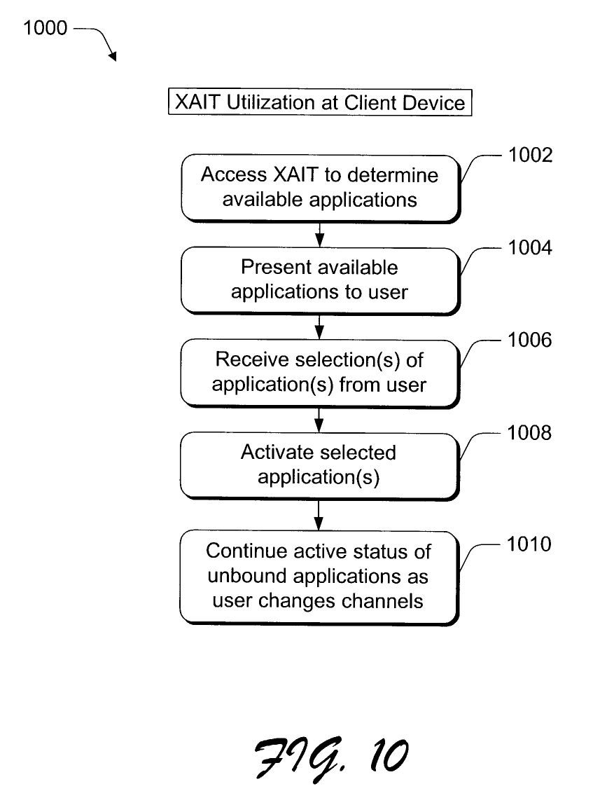

FIG. 10 is a flow diagram 1000 that illustrates a method for utilizing an application information table at a client device of a television entertainment system. At block 1002, the client device accesses the XAIT to determine which applications are available to the client device. Specifically, client device 108 may access XML-based AIT 318 to determine which applications 316 may be (i) activated by a user of client device 108 or (ii) otherwise interacted with by the user. Such applications include bound and unbound applications that a user may elect to execute, display, etc., as well as modify, change, customize, and so forth. At block 1004, these applications that are available to a user are presented thereto. For example, client device 108 may present a list of pertinent applications that a user may elect to activate. Pertinent applications include those applications that are pertinent to current programs or current events, unbound applications that are generally usable, and so forth. The user selects from the applications that are presented thereto using a television 136/138 and/or indicators on client device 108.

At block 1006, the client device receives any selections of applications from a user thereof. In other words, a user of client device 108 may select certain applications of the presented applications for immediate (or subsequent) activation. At block 1008, the client device activates the selected applications. For example, client device 108 may launch a web browser, an e-mail program, a game, and so forth. Alternatively, client device 108 may display a file of text and/or audiovisual material, initiate the display of real-time information that relates to a program or the news, and the like. After applications are activated, the user of client device 108 may cause client device 108 to change channels, or a current program may cease and a subsequent program may start. During either of these events, the active status of any unbound applications is not automatically terminated merely because of the change of channels or programs. Hence, at block 1010, the client device continues the active status of unbound application(s) as the user thereof causes channels to be changed.

[image]

[image]

[image]

[image]

[image]

[image]

[image]

[image]

[image]

[image]

[image]

[image]

[image]

[image]

Conclusion

Although systems and methods have been described in language specific to structural features and/or methods, it is to be understood that the invention defined in the appended claims is not necessarily limited to the specific features or methods described. Rather, the specific features and methods are disclosed as exemplary forms of implementing the claimed invention.

1. A client device for a television-based entertainment system, comprising:
one or more interfaces that are capable of receiving content and applications;
one or more processors that are adapted to process the content and the applications; and
one or more memories that store an application information table, the application information table including a plurality of fields that define applications in an extensible markup language (XML), the plurality of fields divided into a plurality of field sets, each field set of the plurality of field sets associated with an application field of a plurality of application fields;
wherein a service field begets the plurality of application fields.

2. The client device as recited in claim 1, wherein the client device comprises a set-top box.

3. The client device as recited in claim 1, wherein the one or more interfaces comprise at least one cable interface or at least one satellite interface.

4. The client device as recited in claim 1, further comprising:
at least one output that is capable of supplying audio and video information to a television.

5. The client device as recited in claim 1, wherein the service field includes a service identification attribute.

6. The client device as recited in claim 1, wherein the applications comprise one or more software modules, files, images, text, or executable programs.

7. The client device as recited in claim 1, wherein the client device is able to determine which of the applications are available for activation by accessing the application information table.

8. The client device as recited in claim 1, wherein the client device is able to determine how to activate the applications by accessing the application information table.

9. The client device as recited in claim 1, wherein the plurality of fields comprise identifier fields, transport fields, and access fields.

10. The client device as recited in claim 1, wherein the plurality of fields comprise a proxy field, the proxy field including a network address of a proxy server that stores a particular application of the applications; and
wherein the one or more processors are programmed to cause the one or more interfaces to retrieve the particular application from the proxy server using the network address.

11. One or more computer-readable media comprising a schema, the schema comprising:
a routing element that lists at least one relation between a network address and a communication stream; and
a service element that admits a plurality of application elements, each application element of the plurality of application elements defining an associated application, each application element of the plurality of application elements capable of admitting children elements that further define the associated application;
wherein the schema is defined in a markup language and is utilizable in a television-based entertainment system.

12. The one or more computer-readable media as recited in claim 11, wherein the children elements comprise an identifier element, a transport element, and an access element.

13. The one or more computer-readable media as recited in claim 11, wherein the mark up language comprises an extensible markup language (XML).

14. The one or more computer-readable media as recited in claim 11, wherein the associated application of each application element can be utilized by a client device in conjunction with a television.

15. The one or more computer-readable media as recited in claim 11, further comprising:
a proxy element that defines a network address of a proxy server that stores a particular application, the particular application being retrievable from the proxy server using the network address.

16. One or more computer-readable media comprising a schema, the schema comprising:
an application element that relates to an application that is capable of being utilized in conjunction with a television;
a transport element that is a first child of the application element, the transport element including at least one transport protocol that is capable of distributing the application; and
an access element that is a second child of the application element, the access element including at least one access parameter that enables execution of the application;
wherein the schema is applicable to television entertainment environments.

17. The one or more computer-readable media as recited in claim 16, wherein the one or more computer-readable media comprise at least one memory of a client device operable in a television entertainment environment.

18. The one or more computer-readable media as recited in claim 16, wherein the one or more computer-readable media comprise at least one memory of a content distribution system of a television entertainment environment.

19. The one or more computer-readable media as recited in claim 16, wherein the schema comports with an extensible markup language (XML).

20. The one or more computer-readable media as recited in claim 16, wherein the schema enables a client device to access and utilize the application when the schema is provided to the client device from a headend of a television service provider.

21. The one or more computer-readable media as recited in claim 16, further comprising:
an identifier element that is a third child of the application element, the identifier element including at least one of a title and an alphanumeric designation of the application.

22. One or more computer-readable media comprising a schema, the schema comprising:
a plurality of service elements, each service element of the plurality of service elements including a service identification attribute; and
a plurality of application elements that are children elements of a service element of the plurality of service elements, each application element of the plurality of application elements directed to an application of a plurality of applications; each application of the plurality of applications having corresponding features, the corresponding features of each application being mapped to attributes and children elements of each application element;
wherein each application may be activated on a client device in a television entertainment environment by extracting and using information related to the corresponding features in the attributes and children elements of each application element.

23. The one or more computer-readable media as recited in claim 22, wherein each application element of the plurality of application elements comprises at least one tag and corresponding argument of the at least one tag, the at least one tag comporting with an extensible markup language (XML).

24. One or more computer-readable media comprising a schema, the schema comprising:
at least one routing element that admits one or more route elements as children, the at least one routing element pertaining to one or more applications and defining one or more communication links thereof; and
at least one service element that admits one or more application elements as children, each application element of the one or more application elements relating to at least one application of the one or more applications; each application element of the one or more application elements admitting an identifier element that includes identification parameters for an application, a transport element that includes at least one transport protocol for distributing the application, and an access element that includes access parameters for executing the application.

25. The one or more computer-readable media as recited in claim 24, further comprising:
an application information table element, the application information table element admitting the at least one routing element and the at least one service element as children; the application information table element including a version indicator.

26. The one or more computer-readable media as recited in claim 24, wherein a particular element of the schema may be omitted from an application information table if the particular element is not applicable to a particular application or applications of the one or more applications.

27. The one or more computer-readable media as recited in claim 24, wherein the at least one routing element and the at least one service element are drafted in accordance with an extensible markup language (XML).

28. The one or more computer-readable media as recited in claim 24, wherein the at least one application may be active on a client device of a television entertainment environment while a user of the client device changes channels.

29. The one or more computer-readable media as recited in claim 24, wherein the identifier element admits a title element, an icon element, an application domain element, and an application identification element as children thereof.

30. The one or more computer-readable media as recited in claim 29, wherein the title element includes a title of the application, the application identification element includes an identification of the application and an identification of an organization that provides the application, the application domain element includes an Internet-style domain, and the icon element includes at least one of a locator and a flag.

31. The one or more computer-readable media as recited in claim 24, wherein the transport element admits a uniform resource locator (URL) element, a prefetch element, a proxy element, and a diilocation element as children thereof.

32. The one or more computer-readable media as recited in claim 31, wherein the prefetch element includes at least one attribute indicating a preferred prefetching sequence for the application, the URL element includes a URL for multiprotocol encapsulation, the proxy element includes a network address of a proxy server that stores the application; and the diilocation element includes at least one identifier of an object carousel.

33. The one or more computer-readable media as recited in claim 24, wherein the access element admits a parameters element, a base directory element, an application identification values element, an initial class element, a classpath extension element, an initial path element, a physical root element, a boundaries label element, and a boundaries expression element as children thereof.

34. The one or more computer-readable media as recited in claim 33, wherein the parameters element includes at least one start parameter for the application, the base directory element includes a base directory for ocap-j applications, the application identification values element includes an array of application identification values applicable to ocap-html applications, the initial class element includes an initial class for ocap-j applications, the classpath extension element includes a classpath extension for ocap-j applications, the initial path element includes an initial path for ocap-html applications, the physical root element includes a physical root for ocap-html applications, the boundaries label element includes a label for boundaries of ocap-html applications, and the boundaries expression element includes an expression for boundaries of ocap-html applications.

35. One or more computer-readable media comprising a schema, the schema comprising:
a service element that is capable of admitting a plurality of application elements as children elements thereof;
an application element that is a child element of the service element and that defines application-related attributes of at least one application;
a plurality of elements that are children elements of the application element, each element of the plurality of elements defining at least one attribute of a plurality of attributes of the at least one application; the plurality of attributes enabling, at least partly, a client device in a television entertainment environment to utilize the at least one application;
wherein the application element defines the application-related attributes and the plurality of elements define the plurality of attributes of the at least one application using a text-based language.

36. The one or more computer-readable media as recited in claim 35, wherein the text-based language comprises an extensible markup language (XML).

37. The one or more computer-readable media as recited in claim 35, wherein the service element includes a service identification attribute.

38. The one or more computer-readable media as recited in claim 35, wherein the application-related attributes include a launch order attribute, the launch order attribute defining a launch order of a plurality of applications of the plurality of application elements, the plurality of applications including the at least one application.

39. The one or more computer-readable media as recited in claim 35, wherein the plurality of elements includes an application domain element that lists at least one domain name for directly invoking the at least one application.

40. The one or more computer-readable media as recited in claim 35, wherein the plurality of elements includes a proxy element that includes an address of a proxy server, the proxy server storing the at least one application.

41. One or more computer-readable media comprising a data structure, the data structure comprising:
a first field defining an application in textual format; and
a second field defining at least one of an identification, a transport, and an access aspect of the application in the textual format;
wherein the application may be activated in a television entertainment environment.

42. The one or more computer-readable media as recited in claim 41, wherein each of the first field and the second field comprise at least one tag and a corresponding argument.

43. The one or more computer-readable media as recited in claim 41, wherein the one or more computer-readable media comprise a memory of a client device of the television entertainment environment.

44. The one or more computer-readable media as recited in claim 41, wherein the textual format comprises a markup language.

45. The one or more computer-readable media as recited in claim 44, wherein the markup language comprises an extensible markup language (XML).

46. The one or more computer-readable media as recited in claim 41, wherein the application comprises an unbound application that is not bound to a particular program or to a particular channel.

47. A client device for a television entertainment system, the client device comprising:
at least one memory, the at least one memory including:
a first field defining an application in textual format; and
a second field defining at least one of an identification, a transport, and an access aspect of the application in the textual format;
wherein the application may be activated by the client device using information from at least one of the first field and the second field.

48. The client device as recited in claim 47, wherein the first field includes at least one attribute of the application and an argument thereof.

49. The client device as recited in claim 47, wherein the textual format comports with an extensible markup language (XML).

50. The client device as recited in claim 47, further comprising:
at least one network interface for connecting the client device to a headend of the television entertainment system.

51. The client device as recited in claim 47, wherein the client device comprises a set-top box.

52. The client device as recited in claim 47, wherein the second field is directed to a proxy element and includes an address of a proxy server; and wherein the client device is capable of retrieving the application from the proxy server.

53. The client device as recited in claim 47, wherein the first field comprises a version number whose declaration admits any integer number.

54. The client device as recited in claim 47, wherein the first field comprises at least one attribute selected from the group comprising: version, launch order, type, monitor, control, visibility, and priority.

55. A method for creating an application information table, comprising:
receiving information that is associated with a plurality of applications from at least one application provider;
determining a plurality of options for the plurality of applications; and
building an application information table for the plurality of applications by grouping a plurality of application fields that correspond to the plurality of applications under a service field having a service identification, the application information table built responsive to the received information that is associated with the plurality of applications and the determined plurality of options for the plurality of applications;
wherein the application information table is utilizable in a television entertainment system.

56. The method as recited in claim 55, wherein the action of building an application information table comprises selecting tags that pertain to at least one of (i) the received information that is associated with the plurality of applications and (ii) the determined plurality of options for the plurality of applications.

57. The method as recited in claim 55, further comprising:
transmitting the application information table to a client device over a network.

58. The method as recited in claim 55, further comprising:
storing the application information table in a memory of a headend of the television entertainment system.

59. The method as recited in claim 58, wherein the headend comprises an application information formulation system.

60. The method as recited in claim 58, wherein the headend comprises a content distribution system.

61. The method as recited in claim 55, wherein the action of building an application information table comprises combining tags with argument data, the argument data ascertained, at least partially, responsive to at least one of (i) the received information that is associated with the plurality of applications and (ii) the determined plurality of options for the plurality of applications.

62. The method as recited in claim 55, wherein the action of building an application information table comprises building an instantiation of an extensible markup language (XML)-based protocol.

63. A method for communicating an application information table, comprising:
segmenting an application information table into a plurality of packets, the application information table based on an extensible markup language (XML); the application information table including a plurality of entries, each entry of the plurality of entries directed to one or more applications that are capable of activation by a client device in a television-based entertainment system; each entry of the plurality of entries organized under a service field, the service field including a service identification; and
transmitting the plurality of packets onto a network.

64. The method as recited in claim 63, wherein the network comprises at least one of a cable network, a satellite network, and the Internet.

65. The method as recited in claim 63, wherein at least one entry of the plurality of entries includes a transport field that defines, using at least one attribute of the transport field, how to distribute a file in a broadcast manner.

66. The method as recited in claim 63, further comprising:
assigning a packet identification to each packet of the plurality of packets.

67. The method as recited in claim 63, wherein the actions of segmenting and transmitting are performed at a headend of at least one of a cable system and a satellite system.

68. The method as recited in claim 63, wherein at least one entry of the plurality of entries includes at least two fields selected from the group comprising:
an application field, an identifier field, a transport field, and an access field.

69. A method for communicating an application information table, comprising:
receiving a plurality of packets, the plurality of packets including multiple packets directed to an application information table; each packet of the multiple packets corresponding to a predetermined packet identifier;
amalgamating each packet of the plurality of packets that corresponds to the predetermined packet identifier; and
reconstructing the application information table responsive to the action of amalgamating and based on the multiple packets; the application information table comporting with an extensible markup language (XML) and including at least one service field having a service identification, the at least one service field begetting at least one application field that is directed to one or more applications, the one or more applications being utilizable in a television-based entertainment system.

70. The method as recited in claim 69, wherein the actions of receiving, amalgamating, and reconstructing are performed by a client device in the television-based entertainment system.

71. The method as recited in claim 69, further comprising:
determining the predetermined packet identifier by consulting a program map table of the television-based entertainment system.

72. A method for utilizing an application information table, comprising:
accessing an application information table, the application information table including information on a plurality of applications, the information formulated in a markup language format and collected into groups that correspond to individual service providers as indicated by service identifiers;
activating at least one application of the plurality of applications to place the at least one application on active status;
switching from one channel to another channel; and
continuing the active status of the at least one application during the switching action.

73. The method as recited in claim 72, wherein the markup language format comprises an extensible markup language (XML) format.

74. The method as recited in claim 72, wherein the method is performed by a client device that is adapted to operate in a television entertainment system.

75. The method as recited in claim 72, further comprising:
determining, responsive to the accessing action, that the plurality of applications are available;
presenting at least a subset of the plurality of applications to a user; and
receiving at least one selection by the user from among the at least a subset of the plurality of applications to ascertain a selected application.

76. The method as recited in claim 75, wherein the activating action comprises activating the selected application.

77. The method as recited in claim 75, wherein the at least a subset of the plurality of applications comprises those applications that pertain to a current channel or a current program or that are unbound.

78. The method as recited in claim 72, wherein the switching action is performed responsive to user input.

79. The method as recited in claim 72, wherein placing the at least one application on active status comprises at least one of executing the at least one application, interacting with the at least one application, presenting data from the at least one application, and modifying an output of the at least one application.

80. A method for a client device, comprising:
accessing an application information table, the application information table including information on a plurality of applications, the application information table including a service field that begets an application field that begets at least one of an identifier field, a transport field, and an access field;
activating at least one application of the plurality of applications to place the at least one application on active status;
switching between at least two channels or at least two programs; and
continuing the active status of the at least one application during the action of switching;
wherein the client device is designed to operate in a television-based entertainment environment.

81. A method for a client device in a television-based entertainment environment, the method comprising:
accessing an application information table, the application information table formulated in a markup language format;
inspecting a field that defines a proxy server and that is directed to an application, the proxy server storing the application;
extracting a network address from the field, the network address corresponding to the proxy server; and
retrieving the application from the proxy server using the network address.

82. The method as recited in claim 81, further comprising:
activating the application.

83. The method as recited in claim 82, further comprising:
switching from a first channel to a second channel; and
continuing an active status of the application during the switching action.

84. The method as recited in claim 81, wherein the markup language format comprises an extensible markup language (XML) format.

85. The method as recited in claim 81, wherein the action of retrieving the application comprises at least one of the following actions:
retrieving the application over a cable network; and
retrieving the application over the Internet.

86. A content distribution system, comprising:
at least a transmitter for transmitting content and applications over a network;
one or more processors that are adapted to process the content and the applications; and
one or more memories that store an application information table, the application information table including a plurality of fields that define applications in an extensible markup language (XML), the plurality of fields divided into a plurality of field sets, each field set of the plurality of field sets associated with an application field of a plurality of application fields;
wherein a service field begets one or more application fields of the plurality of application fields.

87. The content distribution system as recited in claim 86, wherein the at least a transmitter comprises a transceiver, and the network comprises a bi-directional network.

88. The content distribution system as recited in claim 86, wherein the content comprises television-based entertainment content.

89. The content distribution system as recited in claim 86, wherein the one or more memories further store information that is associated with the applications.

90. The content distribution system as recited in claim 86, wherein the one or more memories further store an XML-based protocol for creating the application information table.

91. A system for a television-based entertainment environment, the system comprising:
at least one memory, the at least one memory including:
a first field defining an application in a textual format; and
a second field defining at least one of an identification, a transport, and an access aspect of the application in the textual format;
wherein the first field and the second field are communicated from the system to a plurality of client devices of the television-based entertainment environment.

92. The system as recited in claim 91, wherein the system comprises a content distribution system.

93. The system as recited in claim 91, wherein the system comprises an application information formulation system.

94. The system as recited in claim 91, wherein the textual format comports with an extensible markup language (XML).

95. The system as recited in claim 91, further comprising:
a stored on-demand applications unit that stores applications to be retrieved by the plurality of client devices.

96. An arrangement for a television-based entertainment system, the arrangement comprising:
means for interfacing with at least one network in order to receive content and applications;
means for processing the content and the applications; and
means for storing a means for conveying application information, the means for conveying application information including a plurality of fields that define applications in an extensible markup language (XML) and that are collected into sets that are associated with individual service identifications.

97. The arrangement as recited in claim 96, further comprising:
means for tuning to at least one television channel of the television-based entertainment system to acquire channel content from the at least one television channel; and
means for outputting audio information and video information that correspond to the channel content.

98. The arrangement as recited in claim 96, further comprising:
means for accessing the plurality of fields to determine how to activate at least one application of the applications; and
means for activating the at least one application.

99. An arrangement for a television-based entertainment system, the arrangement comprising:
means for receiving information that is associated with a plurality of applications;
means for determining a plurality of options for the plurality of applications; and
means for building means for conveying application information for the plurality of applications responsive to the received information that is associated with the plurality of applications and the determined plurality of options for the plurality of applications;
wherein the means for conveying application information organizes application information into sets according to respective service identifications that correspond to each application of the plurality of applications.

100. The arrangement as recited in claim 99, further comprising:
means for transmitting the means for conveying application information to client means for receiving television content over network means for propagating signaling.

101. The arrangement as recited in claim 99, further comprising:
means for transmitting the means for conveying application information to client means for receiving television content over network means for propagating signaling; and
wherein the means for transmitting includes at least one of the following means for distributing the plurality of applications to the client means:
means for distributing the plurality of applications via carouseling;
means for distributing the plurality of applications via server access; and
means for distributing the plurality of applications via a broadcast Internet protocol (IP) multicast stream.
